(19) United States
(12) Patent Application Publication
(10) Pub. No.: US 2007/0215477 A1
(43) Pub. Date: Sep. 20, 2007

(54) Bipolar Chamber and Electrochemical Liquid Treatment Apparatus Having Such Bipolar Chamber

(76) Inventors: Masaji Akahori, Tokyo (JP); Sota Nakagawa, Tokyo (JP); Makoto Kashiwagi, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/597,203

(22) PCT Filed: Jun. 16, 2005
(86) PCT No.: PCT/JP05/11477

§ 371 Date: Nov. 21, 2006

(30) Foreign Application Priority Data
Jun. 18, 2004 (JP) 2004-18159

(51) Int. Cl. B01D 61/42

(52) U.S. Cl. 204/627

(57) ABSTRACT

A bipolar chamber is used in an electrochemical liquid treatment apparatus such as an electrodialyzer and an electrolyzer. The bipolar chamber includes an anion-exchange membrane (1), an electrode (2), and a cation-exchange membrane (3). A liquid is supplied between the cation-exchange membrane (3) and the anion-exchange membrane (1). The anion-exchange membrane (1), the electrode (2), and the cation-exchange membrane (3) are arranged in this order from an anode side of the bipolar chamber. The liquid may include pure water or a nonelectrolyte aqueous solution.

### TECHNICAL FIELD

The present invention relates to a bipolar chamber for use in an electrodialyzer and an electrolyzer, and also relates to an electrochemical liquid treatment apparatus having such a bipolar chamber.

### BACKGROUND ART

There has been known a bipolar chamber for use in an electrodialyzer and an electrolyzer. Examples of such a bipolar chamber are disclosed in Japanese laid-open patent publications No. 54-90079, No. 10-81986, and No. 51-43377. In these examples, a metal forming an electrode is in direct contact with an electrolytic solution which is a liquid to be treated. Accordingly, depending on a property of the liquid, metal corrosion may be accelerated. For example, the above-mentioned Japanese laid-open patent publication No. 54-90079 describes that a concentrated alkaline solution is highly corrosive to titanium.

In addition, when ions in the liquid react with an electrode, a harmful substance or a corrosion-accelerating substance may be produced in a liquid or gas state. Consequently, high costs are incurred in anticorrosion treatment, safety measures, and maintenance for the apparatus. Further, the electrode reaction may produce by-products, which may affect a quality of a product.

### DISCLOSURE OF INVENTION

The present invention has been made in view of the above drawbacks. It is therefore an object of the present invention to provide a novel bipolar chamber which can allow an electrode to have a long service life, can prevent by-products, harmful substances, or corrosive substances from being produced by electrode reaction, and can facilitate maintenance.

Another object of the present invention is to provide an electrochemical liquid treatment apparatus having such a bipolar chamber.

The inventors of the present invention have developed from an extensive study a bipolar chamber which can solve the above problems by using an effective combination of an ion-exchange membrane, an ion exchanger, and an electrode material, and by using water or a non-electrolytic aqueous solution to be supplied to the bipolar chamber.

According to one aspect of the present invention, there is provided a bipolar chamber for use in an electrodialyzer and an electrolyzer. The bipolar chamber comprises an anion-exchange membrane, an electrode, and a cation-exchange membrane. The anion-exchange membrane, the electrode, and the cation-exchange membrane are arranged in this order from an anode side of the bipolar chamber. A liquid is supplied between the cation-exchange membrane and the anion-exchange membrane, and the liquid comprises pure water.

In a preferred aspect of the present invention, a cation exchanger is disposed between the cation-exchange membrane and the electrode.

In a preferred aspect of the present invention, the cation exchanger comprises an ion-exchange nonwoven fabric or an ion-exchange woven fabric comprising a fibrous material.

In a preferred aspect of the present invention, the ion-exchange nonwoven fabric or the ion-exchange woven fabric is produced by utilizing radiation-induced graft polymerization.

In a preferred aspect of the present invention, an anion exchanger is disposed between the anion-exchange membrane and the electrode.

In a preferred aspect of the present invention, the anion exchanger comprises an ion-exchange nonwoven fabric or an ion-exchange woven fabric comprising a fibrous material.

In a preferred aspect of the present invention, the ion-exchange nonwoven fabric or the ion-exchange woven fabric is produced by utilizing radiation-induced graft polymerization.

In a preferred aspect of the present invention, the electrode is made of a conductive material having liquid permeability and gas permeability.

In a preferred aspect of the present invention, the conductive material is selected from an expanded metal, a metallic material having diagonal meshes, a metallic material having latticed meshes, a netlike metallic material, a foam metallic material, and a sintered metallic fabric sheet.

In a preferred aspect of the present invention, the bipolar chamber further comprises a supply port through which the pure water is supplied into the bipolar chamber, and a discharge port through which the pure water and a gas, which is produced by electrolysis, are discharged.

According to another aspect of the present invention, there is provided a bipolar chamber comprising an anion-exchange membrane, an electrode, and a cation-exchange membrane. The anion-exchange membrane, the electrode, and the cation-exchange membrane are arranged in this order from an anode side of the bipolar chamber. A liquid is supplied between the cation-exchange membrane and the anion-exchange membrane, and the liquid comprises a nonelectrolyte aqueous solution.

In a preferred aspect of the present invention, a cation exchanger is disposed between the cation-exchange membrane and the electrode.

In a preferred aspect of the present invention, the cation exchanger comprises an ion-exchange nonwoven fabric or an ion-exchange woven fabric comprising a fibrous material.

In a preferred aspect of the present invention, the ion-exchange nonwoven fabric or the ion-exchange woven fabric is produced by utilizing radiation-induced graft polymerization.

In a preferred aspect of the present invention, an anion exchanger is disposed between the anion-exchange membrane and the electrode.

In a preferred aspect of the present invention, the anion exchanger comprises an ion-exchange nonwoven fabric or an ion-exchange woven fabric comprising a fibrous material.

In a preferred aspect of the present invention, the ion-exchange nonwoven fabric or the ion-exchange woven fabric is produced by utilizing radiation-induced graft polymerization.

In a preferred aspect of the present invention, the electrode is made of a conductive material having liquid permeability and gas permeability.

In a preferred aspect of the present invention, the conductive material is selected from an expanded metal, a metallic material having diagonal meshes, a metallic material having latticed meshes, a netlike metallic material, a foam metallic material, and a sintered metallic fabric sheet.

In a preferred aspect of the present invention, the bipolar chamber further comprises a supply port through which the nonelectrolyte aqueous solution is supplied into the bipolar chamber, and a discharge port through which the nonelectrolyte aqueous solution and a gas, which is produced by electrolysis, are discharged.

According to another aspect of the present invention, there is provided a bipolar chamber comprising an anion-exchange membrane, an anion exchanger, an electrode, a cation exchanger, and a cation-exchange membrane. The anion-exchange membrane, the anion exchanger, the electrode, the cation exchanger, and the cation-exchange membrane are arranged in this order from an anode side of the bipolar chamber.

In a preferred aspect of the present invention, at least one of the cation exchanger and the anion exchanger comprises an ion-exchange nonwoven fabric or an ion-exchange woven fabric comprising a fibrous material.

In a preferred aspect of the present invention, the ion-exchange nonwoven fabric or the ion-exchange woven fabric is produced by utilizing radiation-induced graft polymerization.

In a preferred aspect of the present invention, the electrode is made of a conductive material having liquid permeability and gas permeability.

According to another aspect of the present invention, there is provided an electrochemical liquid treatment apparatus comprising an anode, a cathode, and at least one bipolar chamber described above. The at least one bipolar chamber is disposed between the anode and the cathode.

The bipolar chamber according to the present invention can allow an electrode to have a long service life. Further, the bipolar chamber can prevent by-products, harmful substances, or corrosive substances from being produced by electrode reaction, and can facilitate maintenance. From the standpoint of both environmental protection and resource protection, the present invention is very useful.

### BRIEF DESCRIPTION OF DRAWINGS

Aspects of illustrative, non-limiting embodiments of the present invention will become more apparent by describing in detail embodiments thereof with reference to the attached drawings in which:

FIG. 1 is a view showing one example of a bipolar chamber according to an embodiment of the present invention;

FIG. 2 is a view showing another example of a bipolar chamber according to an embodiment of the present invention;

FIG. 3 is a view showing one example of an electrodialyzer using the bipolar chamber according to an embodiment of the present invention; and

FIG. 4 is a view showing another example of an electrodialyzer using the bipolar chamber according to an embodiment of the present invention.

### BEST MODE FOR CARRYING OUT THE INVENTION

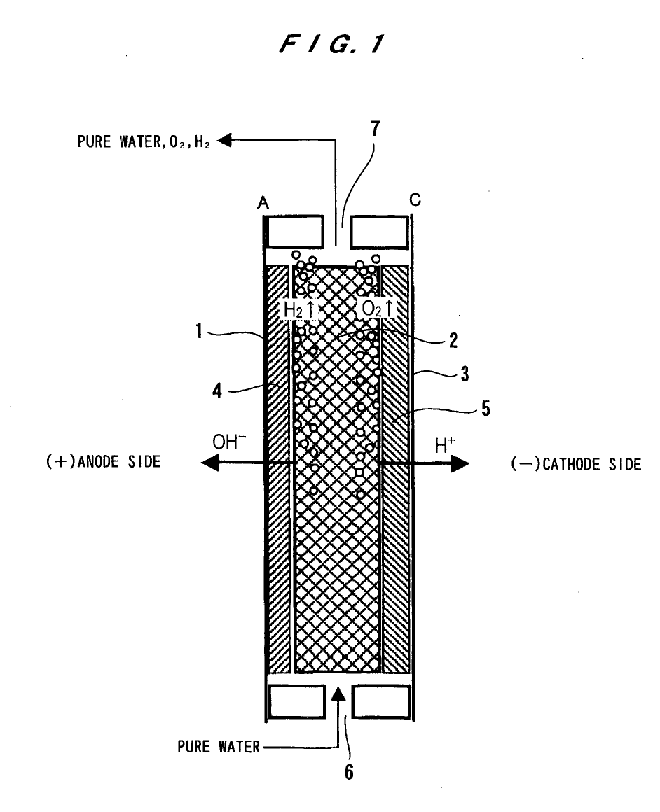

Embodiments of the present invention will be described below with reference to the drawings. As shown in FIG. 1, a bipolar chamber of one embodiment of the present invention comprises an anion-exchange membrane 1, an electrode 2, and a cation-exchange membrane 3, which are arranged in this order from an anode side of the bipolar chamber. An anion-exchange nonwoven fabric 4 serving as an anion exchanger is disposed between the anion-exchange membrane 1 and the electrode 2. A cation-exchange nonwoven fabric 5 serving as a cation exchanger is disposed between the cation-exchange membrane 3 and the electrode 2. The electrode 2 is made of a conductive material having liquid permeability and gas permeability. Such a conductive material having liquid permeability and gas permeability is selected from a lath metal (expanded metal), a metallic material having diagonal meshes, a metallic material having latticed meshes, a netlike metallic material, a foam metallic material, and a sintered metallic fabric sheet.

The bipolar chamber comprises a liquid inlet (supply port) 6 and a liquid outlet (discharge port) 7 which are disposed respectively at a lower portion and an upper portion of the bipolar chamber. A liquid is introduced through the liquid inlet 6 into the bipolar chamber and then passes through cavities of the electrode 2, the cation-exchange nonwoven fabric 5, and the anion-exchange nonwoven fabric 4 to reach the liquid outlet 7. When the bipolar chamber is being energized, an oxygen gas is produced at the cathode side of the electrode 2 and a hydrogen gas is produced at the anode side of the electrode 2 due to electrolysis. These gases pass mainly through the electrode 2 and are discharged through the liquid outlet 7 together with the liquid.

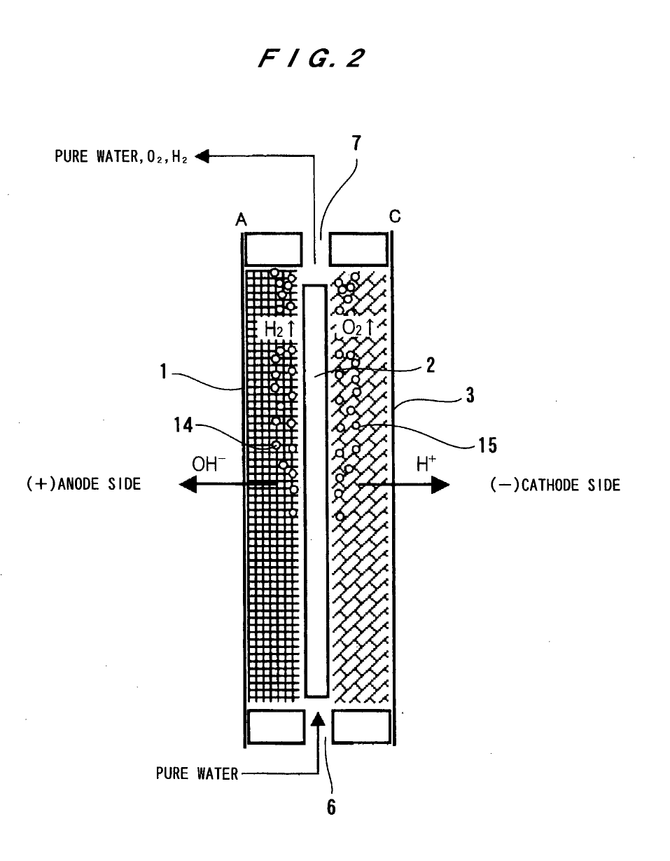

FIG. 2 shows another example of a bipolar chamber according to an embodiment of the present invention. As shown in FIG. 2, the bipolar chamber comprises an anion-exchange membrane 1, an electrode 2, and a cation-exchange membrane 3, which are arranged in this order from an anode side of the bipolar chamber. An anion-exchange spacer 14 serving as an anion exchanger is disposed between the anion-exchange membrane 1 and the electrode 2. A cation-exchange spacer 15 serving as a cation exchanger is disposed between the cation-exchange membrane 3 and the electrode 2. These spacers 14 and 15 have liquid permeability and gas permeability. The electrode 2 has a plate-like shape.

The bipolar chamber comprises a liquid inlet (supply port) 6 and a liquid outlet (discharge port) 7 which are disposed respectively at a lower portion and an upper portion of the bipolar chamber. A liquid is introduced from the liquid inlet 6 into the bipolar chamber and passes through cavities of the cation-exchange spacer 15 and the anion-exchange spacer 14 to reach the liquid outlet 7. When the bipolar chamber is being energized, an oxygen gas is produced at the cathode side of the electrode 2 and a hydrogen gas is produced at the anode side of the electrode 2 due to electrolysis. These gases pass through the cation-exchange spacer 15 and the anion-exchange spacer 14 and are discharged through the liquid outlet 7 together with the liquid. If the liquid outlet 7 is divided into two outlets which are positioned on both sides of the electrode 2, the produced oxygen gas and hydrogen gas can be separated from each other.

Platinum, metal plated with platinum, diamond, or carbon is preferably used as a material for forming the electrode. However, a material for forming the electrode is not limited to these materials so long as the material has an electron conductivity.

Current density to be applied to the ion-exchange membrane (i.e., the anion-exchange membrane and the cation-exchange membrane) is generally set at not more than 3 A/dm². A distance between the anion-exchange membrane and the cation-exchange membrane is generally not more than 10 mm, and preferably not more than 6 mm.

The above-mentioned ion-exchange membrane is commercially available. For example, AHA and CMB, which are manufactured by ASTOM Corporation, can be used respectively for the anion-exchange membrane and the cation-exchange membrane.

As the ion exchanger (i.e., the anion exchanger and the cation exchanger), it is preferable to use a fibrous material comprising polymer fibrous substrates to which ion-exchange groups are introduced by graft polymerization.

The radiation-induced graft polymerization is a technique for introducing a monomer into polymer substrates by irradiating the polymer substrates with radiation rays so as to produce a radical which reacts with the monomer. Radiation rays usable for the radiation-induced graft polymerization include α-rays, β-rays, γ-rays, electron beam, ultraviolet rays, and the like. Of these, γ-rays or electron beam may preferably be used in the present invention. As the radiation-induced graft polymerization, there are a pre-irradiation graft polymerization comprising previously irradiating graft substrates with radiation rays and then contacting the substrates with a grafting monomer, and a co-irradiation method in which irradiation of radiation rays is carried out in the co-presence of substrates and a grafting monomer. Both of these methods may be employed in the present invention. Further, depending upon the manner of contact between a monomer and substrates, there are polymerization methods such as a liquid-phase graft polymerization method in which polymerization is effected while substrates are immersed in a monomer solution, a gas-phase graft polymerization method in which polymerization is effected while substrates are in contact with vapor of monomer, and an immersion gas-phase graft polymerization method in which substrates are firstly immersed in a monomer solution and then removed from the monomer solution and a polymerization is effected in a gas phase. Either method of polymerization may be employed in the present invention.

The substrates of polymer fibers to be grafted may either be single fibers of a polyolefine such as polyethylene or polypropylene, or composite fibers comprising a core portion and a sheath portion which are made of different polymers respectively.

Examples of composite fibers which can be used in the present invention include composite fibers having a core-sheath structure in which a polyolefin such as polyethylene constitutes the sheath and other polymer such as polypropylene which is not used for the sheath constitutes the core. The ion-exchange fibrous materials, which are obtained by introducing ion-exchange groups into the composite fibers by a radiation-induced graft polymerization, are excellent in the ion-exchange capacity and can be produced with a uniform thickness, and therefore are desirable as ion-exchange fibrous materials to be used for the above object. The ion- exchange fibrous material may be in the form of a woven fabric, nonwoven fabric, or the like.

As an ion exchanger in the form a spacer member such as a diagonal net, an ion exchanger comprising a polyolefin resin is preferably used for its excellent ion exchange ability and excellent ability to disperse water to be treated. For example, a polyethylene diagonal net which is widely employed in electrodialysis baths is used as substrates and ion-exchange ability is imparted by utilizing a radiation-induced graft polymerization, then desirable ion exchanger is obtained.

Among the above-described various forms of ion exchangers, an ion-exchange fibrous material in the form of a nonwoven fabric or a woven fabric is particularly preferable. A fibrous material, such as a woven fabric or a nonwoven fabric, has a remarkably large surface area compared with materials in the form of resin beads, a diagonal net, or the like, and therefore a larger amount of ion exchange groups can be introduced thereinto. Further, unlike resin beads in which ion-exchange groups are present in micropores or macropores within the beads, all the ion-exchange groups are present on the surfaces of fibers of an ion-exchange fibrous material. Accordingly, metal ions in water to be treated can easily diffuse into the vicinity of ion-exchange groups, and the ions are adsorbed by means of ion exchange. Therefore, the use of an ion-exchange fibrous material can thus improve removal and recovery efficiency of metal ions.

Known ion-exchange resin beads can also be used in the present invention, other than the above-mentioned ion-exchange fibrous material. For example, it is possible to use strongly acidic cation-exchange resin beads which are obtained by using beads as a basic resin comprising polystyrene which is crosslinked with divinylbenzene and sulfonating the beads with a sulfonating agent such as sulfuric acid or chlorosulfonic acid to introduce sulfonic group into the basic resin. This production method is known in the art and a variety of products of cation-exchange resin beads produced by this method are commercially available. It is also possible to use the resin beads which have various functional groups such as functional groups derived from iminodiacetic acid and its sodium salt, functional groups derived from various amino acids such as phenylalanine, lysine, leucine, valine, proline and their sodium salts, and functional groups derived from iminodiethanol.

The ion-exchange groups to be introduced into fibrous substrates such as a nonwoven fabric, or into spacer substrates are not particularly limited. Various kinds of cation-exchange groups and anion-exchange groups can be used. For instance, usable cation-exchange groups include strongly acidic cation-exchange groups such as sulfo group, moderately acidic cation-exchange groups such as phosphoric group, and weakly acidic cation-exchange groups such as carboxy group. Usable anion-exchange groups include weakly basic anion-exchange groups such as primary, secondary and tertially amino groups, and strongly basic anion-exchange groups such as quaternary ammonium group. Further, an ion exchanger having both of the above-described cation and anion groups may also be employed.

Furthermore, it is also possible to use an ion exchanger having functional groups such as functional groups derived from iminodiacetic acid or its sodium salt, functional groups derived from various amino acids including phenylalanine, lysine, leucine, valine, proline or their sodium salts, or functional groups derived from iminodiethanol.

Monomers having an ion-exchange group usable for this purpose may include acrylic acid (AAc), methacrylic acid, sodium styrenesulfonate (SSS), sodium methallylsulfonate, sodium allylsulfonate, sodium vinylsulfonate, vinylbenzyl trimethylammonium chloride (VBTAC), diethylaminoethyl methacrylate, and dimethylaminopropylacrylamide.

Sulfo group as a strongly acidic cation-exchange group, for example, may be introduced directly into substrates by carrying out radiation-induced graft polymerization in which sodium styrenesulfonate is used as a monomer. Quaternary ammonium group as a strongly basic anion-exchange group may be introduced directly into substrates by carrying out radiation-induced graft polymerization in which vinylbenzyl trimethylammonium chloride is used as a monomer.

Examples of the monomer having groups that can be converted into ion-exchange groups include acrylonitrile, acrolein, vinylpyridine, styrene, chloromethylstyrene, and glycidyl methacrylate (GMA). Sulfo group as a strongly acidic cation-exchange group, for example, may be introduced into substrates in such a manner that glycidyl methacrylate is introduced into the substrates by radiation-induced graft polymerization, and then react with a sulfonating agent such as sodium sulfite. Quaternary ammonium group as a strongly basic anion-exchange group may be introduced into substrates in such a manner that chloromethylstyrene is graft-polymerized onto substrates and then the substrates are immersed into an aqueous solution of trimethylamine to effect quaternary-ammonification.

Further, sodium iminodiacetate group as a functional group can be introduced into substrates in such a manner that chloromethylstyrene is graft-polymerized onto substrates and the substrates react with a sulfide to make a sulfonium salt, and then the sulfonium salt reacts with sodium iminodiacetate. Alternatively, sodium iminodiacetate as a functional group may be introduced into substrates in such a manner that chloromethylstyrene is graft-polymerized onto substrates and chloro group is substituted with iodine group and iodine group reacts with an iminodiacetic acid diethyl ester to substitute iodine group with an iminodiacetic acid diethyl ester group, and finally the ester group reacts with sodium hydroxide to convert the ester group into sodium salt.

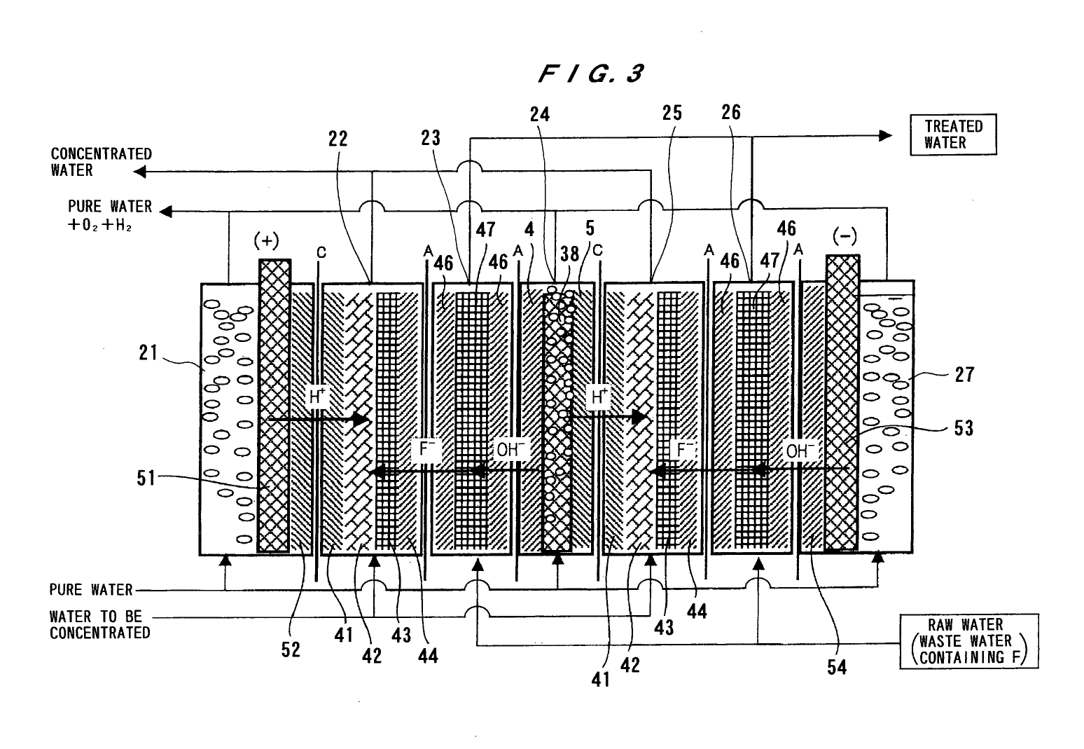

FIG. 3 shows an example of an electrodialyzer using the bipolar chamber according to an embodiment of the present invention. The electrodialyzer shown in FIG. 3 is designed to selectively separate fluorine, which is an anion, from raw water (a liquid to be treated) and concentrate the fluorine. The electrodialyzer has seven chambers comprising an anode chamber 21, a neutralization chamber 22, a deionization chamber 23, a bipolar chamber 24, a neutralization chamber 25, a deionization chamber 26, and a cathode chamber 27. The deionization chambers 23 and 26 are provided for selectively removing only anions from the liquid so as to produce a treated liquid containing a low concentration of anions. The neutralization chambers 22 and 25 are provided for electrically neutralizing the anions, which were introduced from the deionization chambers 23 and 26, with hydrogen ions supplied from the anode chamber 21 or the bipolar chamber 24.

A cation-exchange membrane C is disposed between the anode chamber 21 and the neutralization chamber 22, an anion-exchange membrane A is disposed between the neutralization chamber 22 and the deionization chamber 23, and an anion-exchange membrane A is disposed between the deionization chamber 23 and the bipolar chamber 24. Further, a cation-exchange membrane C is disposed between the bipolar chamber 24 and the neutralization chamber 25, an anion-exchange membrane A is disposed between the neutralization chamber 25 and the deionization chamber 26, and an anion-exchange membrane A is disposed between the deionization chamber 26 and the cathode chamber 27.

The bipolar chamber 24 has an anion-exchange nonwoven fabric 4 and a cation-exchange nonwoven fabric 5, both of which are a type of ion-exchange nonwoven fabric. The anion-exchange nonwoven fabric 4 and the cation-exchange nonwoven fabric 5 are disposed on both sides of a lath metal electrode 38. The raw water is supplied to the deionization chambers 23 and 26 disposed between the anion-exchange membranes A and A, and is captured by anion exchangers (i.e., anion-exchange spacers, anion-exchange nonwoven fabrics) provided in the deionization chambers 23 and 26. DC voltage is applied in advance between an anode 51 and a cathode 53, so that hydroxide ions, which were produced by electrolysis in the cathode chamber 27 and the bipolar chamber 24, move to the anode side, and the anions, which were captured by the anion exchangers (i.e., anion-exchange spacers, anion-exchange nonwoven fabrics) provided in the deionization chambers 23 and 26, move into the neutralization chambers 22 and 25 through the anion-exchange membrane A. In the anode chamber 21 and the bipolar chamber 24, the hydrogen ions produced by electrolysis move toward the cathode side. Specifically, the hydrogen ions in the anode chamber 21 move into the neutralization chamber 22 through the cation-exchange membrane C, and the hydrogen ions in the bipolar chamber 24 move into the neutralization chamber 25 through the cation-exchange membrane C.

Each of the neutralization chambers 22 and 25 is filled with a cation-exchange nonwoven fabric 41, a cation-exchange spacer 42, an anion-exchange spacer 43, and an anion-exchange nonwoven fabric 44, which are arranged in this order from the anode side of the bipolar chamber 24. All types of cation exchangers and anion exchangers can be used for the cation-exchange spacer 42 and the anion-exchange spacer 43, respectively, which are provided between the cation-exchange nonwoven fabric 41 and the anion-exchange nonwoven fabric 44. Each of the deionization chambers 23 and 26 is filled with anion-exchange nonwoven fabrics 46 and an anion-exchange spacer 47.

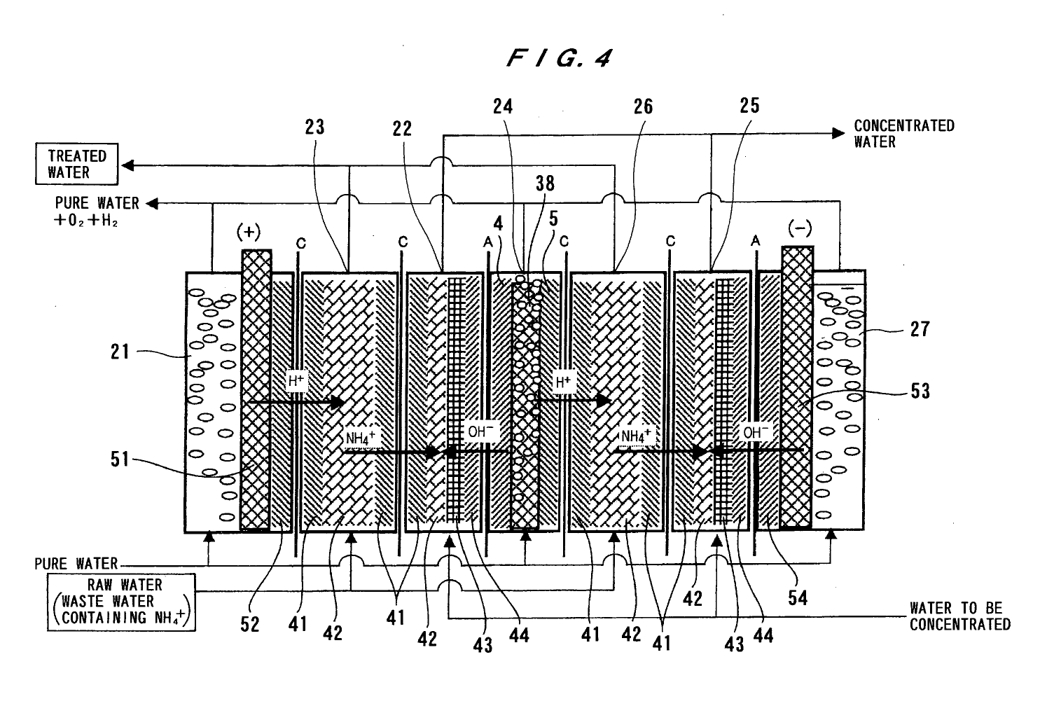

FIG. 4 shows another example of an electrodialyzer using the bipolar chamber according to an embodiment of the present invention. The electrodialyzer shown in FIG. 4 is designed to selectively separate NH₄⁺, which is a cation, from raw water (a liquid to be treated) and concentrate NH₄⁺. The electrodialyzer has seven chambers comprising an anode chamber 21, a deionization chamber 23, a neutralization chamber 22, a bipolar chamber 24, a deionization chamber 26, a neutralization chamber 25, and a cathode chamber 27. The deionization chambers 23 and 26 are provided for selectively removing only cations from the liquid to produce a treated liquid containing a low concentration of cations. The cations move from the deionization chambers 23 and 26 into the neutralization chambers 22 and 25, where the cations are electrically neutralized with hydroxide ions supplied from the bipolar chamber 24 or the cathode chamber 27.

A cation-exchange membrane C is disposed between the anode chamber 21 and the deionization chamber 23, a cation-exchange membrane C is disposed between the deionization chamber 23 and the neutralization chamber 22, and an anion-exchange membrane A is disposed between the neutralization chamber 22 and the bipolar chamber 24. Further, a cation-exchange membrane C is disposed between the bipolar chamber 24 and the deionization chamber 26, a cation-exchange membrane C is disposed between the deionization chamber 26 and the neutralization chamber 25, and an anion-exchange membrane A is disposed between the neutralization chamber 25 and the cathode chamber 27.

The bipolar chamber 24 has an anion-exchange nonwoven fabric 4 and a cation-exchange nonwoven fabric 5, both of which are a type of ion-exchange nonwoven fabric. The anion-exchange nonwoven fabric 4 and the cation-exchange nonwoven fabric 5 are disposed on both sides of a lath metal electrode 38. The raw water is supplied to the deionization chambers 23 and 26 disposed between the cation-exchange membranes C and C, and is captured by cation exchangers (i.e., cation-exchange spacers, cation-exchange nonwoven fabrics) provided in the deionization chambers 23 and 26. DC voltage is applied in advance between an anode 51 and a cathode 53, so that hydrogen ions, which were produced by electrolysis in the anode chamber 21 and the bipolar chamber 24, move to the cathode side, and the cations, which were captured by the cation exchangers (i.e., cation-exchange spacers, cation-exchange nonwoven fabrics) provided in the deionization chambers 23 and 26, move into the neutralization chambers 22 and 25 through the cation-exchange membrane C. In the bipolar chamber 24 and the cathode chamber 27, the hydroxide ions produced by electrolysis move toward the anode side. Specifically, the hydroxide ions in the bipolar chamber 24 move into the neutralization chamber 22 through the anion-exchange membrane A, and the hydroxide ions in the cathode chamber 27 move into the neutralization chamber 25 through the anion-exchange membrane A.

Each of the neutralization chambers 22 and 25 is filled with a cation-exchange nonwoven fabric 41, a cation-exchange spacer 42, an anion-exchange spacer 43, and an anion-exchange nonwoven fabric 44, which are arranged in this order from the anode side of the bipolar chamber 24. All types of cation exchangers and anion exchangers can be used for the cation-exchange spacer 42 and the anion-exchange spacer 43, respectively, which are provided between the cation-exchange nonwoven fabric 41 and the anion-exchange nonwoven fabric 44. Each of the deionization chambers 23 and 26 is filled with cation-exchange nonwoven fabrics 41 and a cation-exchange spacer 42.

In FIGS. 3 and 4, the anode chamber 21 has a cation-exchange nonwoven fabric 52 disposed between the electrode 51 of lath metal (i.e., expanded metal) and the cation-exchange membrane C. The cathode chamber 27 has an anion-exchange nonwoven fabric 54 disposed between the electrode 53 of lath metal (i.e., expanded metal) and the anion-exchange membrane A. Since the anode chamber 21 and the cathode chamber 27 use the electrodes 51 and 53 of lath metal (i.e., expanded metal), respectively, an oxygen gas or a hydrogen gas produced by electrolysis is discharged outwardly through cavities formed in the electrodes 51 and 53 to the exterior. Accordingly, the gas, which is an insulation substance, is not trapped inside the cation-exchange nonwoven fabric 52 or the anion-exchange nonwoven fabric 54, and hence electrical resistance is prevented from increasing.

It is desirable to use pure water as a liquid to be supplied to the anode chamber 21, the cathode chamber 27, and the bipolar chamber 24. Usable pure water is not particularly limited. All types of pure waters produced by processes known in the art can be used. For example, known techniques such as RO (reverse osmosis) membrane, ion exchange, distillation, electric desalting, or a combination of these can be used to produce pure water. It is also possible to use ultrapure water that is produced by further purifying such pure water. Instead of pure water, a nonelectrolyte aqueous solution may be used. For example, pure water containing about 0.5 mg/L of isopropyl alcohol can be used.

The present invention will be further described below with reference to a specific example. It should be noted that the present invention is not limited to the following example.

### EXAMPLE

An experiment was conducted using the electrodialyzer shown in FIG. 3. Waste water containing 500 mg F/L of fluoride ions released from a semiconductor manufacturing facility was used as raw water. Pure water was used as water to be concentrated, and this water was circulated. Pure water was used as an electrode liquid which is to be supplied to the anode chamber, the cathode chamber, and the bipolar chamber. The bipolar chamber was filled with the anion-exchange nonwoven fabric, the lath metal (expanded metal) electrode, and the cation-exchange nonwoven fabric, which were arranged in this order from the anode side of the bipolar chamber. A material of the lath metal (expanded metal) electrode was titanium plated with platinum. Current density was set at 3 A/dm². SV (superficial velocity) of the raw water, the water to be concentrated, and the pure water was set at 50 to 100 l/hr.

Results of the experiment were as follows: A concentration of fluoride ions in the treated water was 1 to 3 mg/L. An operating voltage was kept low at 40 V. Fluoride ions contained in the raw water were concentrated to not less than 5000 mg/L, and hydrogen fluoride water was obtained. From these results, it was confirmed that the bipolar chamber could electrolyze pure water and functioned as an electrode.

Cation-exchange nonwoven fabric: produced by graft polymerization. Polyethylene nonwoven fabric was used as substrates. Functional group was sulfo group.

Anion-exchange nonwoven fabric: produced by graft polymerization. Polyethylene nonwoven fabric was used as substrates. Functional group was quaternary ammonium group.

Cation-exchange spacer: produced by graft polymerization. Polyethylene diagonal net was used as substrates. Functional group was sulfo group.

Anion-exchange spacer: produced by graft polymerization. Polyethylene diagonal net was used as substrates. Functional group was quaternary ammonium group.

Anode: lath metal (expanded metal) made of titanium plated with platinum

Cathode: lath metal (expanded metal) made of SUS 304

Cation-exchange membrane: CMB manufactured by ASTOM Corporation

Anion-exchange membrane: AHA manufactured by ASTOM Corporation

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims and equivalents.

### INDUSTRIAL APPLICABILITY

The present invention is applicable to a bipolar chamber for use in an electrodialyzer and an electrolyzer, and is also applicable to an electrochemical liquid treatment apparatus.

1. A bipolar chamber for use in an electrodialyzer and an electrolyzer, said bipolar chamber comprising:
an anion-exchange membrane;
an electrode; and
a cation-exchange membrane;
wherein said anion-exchange membrane, said electrode, and said cation-exchange membrane are arranged in this order from an anode side of said bipolar chamber;
wherein a liquid is supplied between said cation-exchange membrane and said anion-exchange membrane; and
wherein the liquid comprises pure water.

2. A bipolar chamber according to claim 1, further comprising a cation exchanger disposed between said cation-exchange membrane and said electrode.

3. A bipolar chamber according to claim 2, wherein said cation exchanger comprises an ion-exchange nonwoven fabric or an ion-exchange woven fabric comprising a fibrous material.

4. A bipolar chamber according to claim 3, wherein said ion-exchange nonwoven fabric or said ion-exchange woven fabric is produced by utilizing radiation-induced graft polymerization.

5. A bipolar chamber according to claim 1, further comprising an anion exchanger disposed between said anion-exchange membrane and said electrode.

6. A bipolar chamber according to claim 5, wherein said anion exchanger comprises an ion-exchange nonwoven fabric or an ion-exchange woven fabric comprising a fibrous material.

7. A bipolar chamber according to claim 6, wherein said ion-exchange nonwoven fabric or said ion-exchange woven fabric is produced by utilizing radiation-induced graft polymerization.

8. A bipolar chamber according to claim 1, wherein said electrode is made of a conductive material having liquid permeability and gas permeability.

9. A bipolar chamber according to claim 8, wherein said conductive material is selected from an expanded metal, a metallic material having diagonal meshes, a metallic material having latticed meshes, a netlike metallic material, a foam metallic material, and a sintered metallic fabric sheet.

10. A bipolar chamber according to claim 1, further comprising:
a supply port through which the pure water is supplied into said bipolar chamber; and
a discharge port through which the pure water and a gas, which is produced by electrolysis, are discharged.

11. A bipolar chamber for use in an electrodialyzer and an electrolyzer, said bipolar chamber comprising:
an anion-exchange membrane;
an electrode; and
a cation-exchange membrane;
wherein said anion-exchange membrane, said electrode, and said cation-exchange membrane are arranged in this order from an anode side of said bipolar chamber;
wherein a liquid is supplied between said cation-exchange membrane and said anion-exchange membrane; and
wherein the liquid comprises a nonelectrolyte aqueous solution.

12. A bipolar chamber according to claim 11, further comprising a cation exchanger disposed between said cation-exchange membrane and said electrode.

13. A bipolar chamber according to claim 12, wherein said cation exchanger comprises an ion-exchange nonwoven fabric or an ion-exchange woven fabric comprising a fibrous material.

14. A bipolar chamber according to claim 13, wherein said ion-exchange nonwoven fabric or said ion-exchange woven fabric is produced by utilizing radiation-induced graft polymerization.

15. A bipolar chamber according to claim 11, further comprising an anion exchanger disposed between said anion-exchange membrane and said electrode.

16. A bipolar chamber according to claim 15, wherein said anion exchanger comprises an ion-exchange nonwoven fabric or an ion-exchange woven fabric comprising a fibrous material.

17. A bipolar chamber according to claim 16, wherein said ion-exchange nonwoven fabric or said ion-exchange woven fabric is produced by utilizing radiation-induced graft polymerization.

18. A bipolar chamber according to claim 11, wherein said electrode is made of a conductive material having liquid permeability and gas permeability.

19. A bipolar chamber according to claim 18, wherein said conductive material is selected from an expanded metal, a metallic material having diagonal meshes, a metallic material having latticed meshes, a netlike metallic material, a foam metallic material, and a sintered metallic fabric sheet.

20. A bipolar chamber according to claim 11, further comprising:
a supply port through which the nonelectrolyte aqueous solution is supplied into said bipolar chamber; and
a discharge port through which the nonelectrolyte aqueous solution and a gas, which is produced by electrolysis, are discharged.

21. A bipolar chamber for use in an electrodialyzer and an electrolyzer, said bipolar chamber comprising:
an anion-exchange membrane;
an anion exchanger;
an electrode;
a cation exchanger; and
a cation-exchange membrane;
wherein said anion-exchange membrane, said anion exchanger, said electrode, said cation exchanger, and said cation-exchange membrane are arranged in this order from an anode side of said bipolar chamber.

22. A bipolar chamber according to claim 21, wherein at least one of said cation exchanger and said anion exchanger comprises an ion-exchange nonwoven fabric or an ion-exchange woven fabric comprising a fibrous material.

23. A bipolar chamber according to claim 22, wherein said ion-exchange nonwoven fabric or said ion-exchange woven fabric is produced by utilizing radiation-induced graft polymerization.

24. A bipolar chamber according to claim 21, wherein said electrode is made of a conductive material having liquid permeability and gas permeability.

25. An electrochemical liquid treatment apparatus, comprising:
an anode;
a cathode; and
at least one bipolar chamber according to claim 1, said at least one bipolar chamber being disposed between said anode and said cathode.

26. An electrochemical liquid treatment apparatus, comprising:
an anode;
a cathode; and
at least one bipolar chamber according to claim 11, said at least one bipolar chamber being disposed between said anode and said cathode.

27. An electrochemical liquid treatment apparatus, comprising:
an anode;
a cathode; and
at least one bipolar chamber according to claim 21, said at least one bipolar chamber being disposed between said anode and said cathode.
